(19) United States
(12) Patent Application Publication
(10) Pub. No.: US 2025/0033341 A1
(43) Pub. Date: Jan. 30, 2025

(54) METHOD FOR BONDING POLYIMIDE FILM, BONDING DEVICE, AND BONDED STRUCTURE HAVING POLYIMIDE FILM BONDING PART

(71) Applicant: NATIONAL UNIVERSITY CORPORATION OKAYAMA UNIVERSITY, Okayama-shi, Okayama (JP)

(72) Inventors: Daisuke YAMAGUCHI, Okayama-shi (JP); Akari NAGASAKI, Okayama-shi (JP); Ryo MORIGAKI, Okayama-shi (JP); Ryotaro KAMIMURA, Okayama-shi (JP); Kazuki TAKAI, Okayama-shi (JP); Yosuke KATO, Okayama-shi (JP)

(73) Assignee: NATIONAL UNIVERSITY CORPORATION OKAYAMA UNIVERSITY, Okayama-shi, Okayama (JP)

(21) Appl. No.: 18/712,729

(22) PCT Filed: Nov. 25, 2022
(86) PCT No.: PCT/JP2022/043521

§ 371 Date: May 23, 2024

(30) Foreign Application Priority Data
Nov. 26, 2021 (JP) 2021-192505

(51) Int. Cl. B32B 37/06; B32B 15/08; B32B 27/08; B32B 27/28; B32B 37/10

(52) U.S. Cl. CPC B32B 37/065; B32B 15/08; B32B 27/08; B32B 27/281; B32B 37/10; B32B 2250/02; B32B 2309/025; B32B 2310/0843; B32B 2379/08

(57) ABSTRACT

A polyimide film bonding method according to an embodiment may include: bonding two polyimide films to each other by bringing a hot plate into contact with a portion where the two polyimide films are superposed. A heating temperature by the contact with the hot plate is 450° C. or higher. A contact time between the polyimide films and the hot plate is 12 seconds or less. A polyimide film bonding method according to another embodiment may include: bonding two polyimide films to each other by irradiating, with a laser beam, a portion where the two polyimide films are superposed. A top surface of the superposed polyimide films is irradiated with the laser beam while a bottom surface of the superposed polyimide films is kept tightly attached to a heat insulator.

### TECHNICAL FIELD

The present invention relates to a polyimide film bonding method, a bonding device, and a bonded structure having a polyimide film bonding part.

### BACKGROUND ART

Polyimide is an organic polymer obtained by condensation polymerization of a dianhydride and a diamine. Among various polyimides, “KAPTON®” is a traditional aromatic polyimide developed by DuPont de Nemours, Inc. Being highly heat resistant and highly insulative, aromatic polyimides including KAPTON have attractive properties, in particular, as a material for items to be used in extreme environments hardly accessible by humans, such as in the space environment, the high-temperature environment, the extremely low-temperature environment, and acidic/alkaline solutions.

On the other hand, the aromatic polyimides generally melt at very high temperatures. It is often the case that their melting points are close to their thermal decomposition temperatures or that their melting points are difficult to identify (in this specification, “a polyimide whose melting point is close to its thermal decomposition temperature or whose melting point is difficult to identify” is called “difficult-to-melt polyimide”). An attempt to melt such polyimides by heating results in pore formation or carbonization, and hence thermal bonding (welding) of such polyimides was considered impossible.

Since thermal bonding was considered impossible, films made of difficult-to-melt polyimides (hereinafter simply called “difficult-to-melt polyimide films”) were bonded to each other with use of fixing metal parts such as screws and bolts or adhesive agents. Use of adhesive agents, however, has caused following problems. Adhesive agents, which are generally less resistant to heat than difficult-to-melt polyimides, degrade heat resistance of the difficult-to-melt polyimides that is one of the attractive characteristics of the difficult-to-melt polyimides. The product performance of the difficult-to-melt polyimide films thus depends on the performance of adhesive agents. Besides, adhesive agents tend to increase the thickness of the bonded portion and to increase the mass. Use of fixing metal parts such as screws and bolts has also caused following problems: tearing of the film from through-holes for the fixing metal parts, heat conduction through the fixing metal parts, considerable increase in the mass, and difficulty in manufacturing a structure like an airtight chamber.

As a method for bonding the difficult-to-melt polyimide films to each other, pretreatment of the polyimide films by plasma irradiation has been investigated as disclosed in Non-Patent Document 1 and Non-Patent Document 2. In this method, both welding surfaces of polyimide films to be bonded are subjected to plasma irradiation, and thermal welding is effected after top layers of these welding surfaces have been activated by the plasma irradiation. Since the plasma activation does not last for a long time, the irradiation step and the welding step are repeated locally to conduct the bonding. However, this method not only involves some problems, such as a need for dust-proof measures like a clean room, an increase in the number of bonding steps, and deterioration of productivity, but also involves additional difficulties in bonding films of complex shapes and in increasing the area of a bonding part. Due to these problems and difficulties, this method is not currently utilized except in special applications.

An alternative approach has been made to enable welding by introducing thermoplastic segments into aromatic polyimides, thereby lowering their glass transition temperatures and melting points and increasing a temperature difference from their thermal decomposition temperatures.

Patent Document 1 discloses a polyimide film bonding method, in which polyimide films having a specific repeating unit are thermally melted at 240° C. to 430° C. and pressure bonded.

Nevertheless, no one has found a method for bonding difficult-to-melt polyimides in which the difficult-to-melt polyimides are thermally bonded without treatment, without any chemical modification such as introduction of thermoplastic segments into the difficult-to-melt polyimides.

### CITATION LIST

### Patent Literature

Patent Document 1: JP H03-192177 A

### Non-Patent Literature

Non-Patent Document 1: Mission Project of the Mars Society Germany (H. S. Griebel, R. Foerstner, C. Mundt, A. Mohr, W. Mai, J. Polkko, H. N. Teodorescu, G. Herdrich, S. Fasoulas, T. Marynowski, A. Stamminger, D. Heyner, “The Mission MIRIAM-2: Putting a Gossamer Ballute Through An Atmospheric Entry FLight Test”, Conference: 8th Annual International Planetary Probe Workshop, 2011)
Non-Patent Document 2: Kawamura Sangyo Co., Ltd., “Plasma surface treatment”, [online], [Date searched: Jul. 13, 2021], Internet <URL: https://www.kawamura-s.co.jp/processing_plasma/>

### SUMMARY OF INVENTION

### Technical Problem

The present invention is made under the above-described circumstances where a method for processing difficult-to-melt polyimide films simply without treatment has been awaited. An object of the present invention is to provide a bonding method and a bonding device that enable direct bonding of one or more difficult-to-melt polyimide films without using any adhesive agent, fixing metal part or the like, and also to provide a bonded structure having a polyimide film bonding part.

### Solution to Problem

Although thermal bonding of difficult-to-melt polyimide films was conventionally considered impossible, the inventors of the present invention have made an intensive study to solve the above-mentioned problems. The present inventors have eventually found a method for bonding difficult-to-melt polyimide films by heating, a bonding device to be used in the method, and more, and have completed the present invention.

Specifically, an invention made to solve the above object provides a method for bonding polyimide films to each other. To bond two polyimide films to each other by bringing a hot plate into contact with a portion where the two polyimide films are superposed, this bonding method is characterized in that a heating temperature by the contact with the hot plate is 450° C. or higher, and that a contact time between the polyimide films and the hot plate is 12 seconds or less.

Another invention made to solve the above object provides a method for bonding polyimide films to each other. This method is characterized in that a conductive member is used as the hot plate. While the conductive member has been kept in contact with the polyimide films in a tightly attached manner under a pressure, the conductive member is heated instantaneously by application of a voltage to the conductive member, and is thereby allowed to serve as the hot plate.

Another invention made to solve the above object provides a method for bonding polyimide films to each other. To bond two polyimide films to each other by irradiating, with a laser beam, a portion where the two polyimide films are superposed, this bonding method is characterized in that a top surface of the superposed polyimide films is irradiated with the laser beam while a bottom surface of the superposed polyimide films is kept tightly attached to a heat insulator.

According to these inventions, difficult-to-melt polyimide films that have not undergone chemical modification such as introduction of thermoplastic segments can be directly bonded to each other, without using any adhesive agent, fixing metal part, or the like.

Another invention made to solve the above object provides a film bonding device including a support member that supports a bottom surface of a film or films, and a laser emission part that emits a laser beam onto the film or films. The bonding device is characterized in that the support member has an insulating layer at a position to be in contact with the bottom surface of the film or films, that the insulating layer includes a surface layer to be in contact with the film or films and a vacuum layer placed under the surface layer, and that the surface layer is made of a thermosetting polyimide film.

According to this film bonding device, polyimide films can be directly bonded to each other without using any adhesive agent, fixing metal part, or the like. In addition, difficult-to-melt polyimide films that have not undergone chemical modification such as introduction of thermoplastic segments can be directly bonded to each other.

Another invention made to solve the above object provides a polyimide film including a bonding part where polyimide films are bonded to each other by the above bonding methods according to the present invention.

Owing to the direct bonding between the polyimide films, the polyimide film including the bonding part can solve the above-mentioned problems caused by the use of adhesive agents, fixing metal parts, or the like. Further, the polyimide film obtained by the above-described bonding methods according to the present invention can be composed of difficult-to-melt polyimide films that are directly bonded to each other, wherein the difficult-to-melt polyimide films have not undergone chemical modification such as introduction of thermoplastic segments, and wherein the difficult-to-melt polyimide films retain their inherently high melting point and glass transition temperature.

Another invention made to solve the above object provides a polyimide film bonding method. This bonding method is characterized by bonding a polyimide film to a metal by heating the polyimide film while a contact pressure is applied such that one surface of the polyimide film is tightly attached to a surface of the metal.

According to the above bonding method, a difficult-to-melt polyimide films that has not undergone chemical modification such as introduction of thermoplastic segments can be directly bonded to a metal, without using any adhesive agent, fixing metal part, or the like.

Another invention made to solve the above object provides a bonded structure including a polyimide film and a metal. This bonded structure is characterized by including a bonding part where the polyimide film and a surface of the metal are bonded to each other by the above bonding method.

Owing to the direct bonding between the polyimide film and a surface of the metal, the bonded structure can solve the above-mentioned problems caused by the use of adhesive agents, fixing metal parts, or the like. Further, the bonded structure obtained by the above-described bonding method can be composed of a difficult-to-melt polyimide film directly bonded to a metal, wherein the difficult-to-melt polyimide film has not undergone chemical modification such as introduction of thermoplastic segments, and wherein the difficult-to-melt polyimide film retains its inherently high melting point and glass transition temperature.

### Advantageous Effects of Invention

The present invention can provide a bonding method and a bonding device that enable direct bonding of one or more difficult-to-melt polyimide films without using any adhesive agent, fixing metal part or the like, and also to provide a bonded structure having a polyimide film bonding part.

### BRIEF DESCRIPTION OF DRAWINGS

FIG. 1 is a photographic copy showing a device used to conduct hot plate bonding.

FIG. 2 is a schematic front view showing an example of the hot plate bonding.

FIG. 3 shows photographic copies regarding an example of a conductive member used as a hot plate in the hot plate bonding, and regarding a state of temperature when the conductive member is heated by application of a voltage.

FIG. 4 is a schematic front view showing an example of the bonding with use of the conductive member.

FIG. 5 is a photographic copy showing a device used to conduct CO₂ laser bonding.

FIG. 6 is a schematic front view showing an example of the CO₂ laser bonding.

FIG. 7 is a schematic front view showing an example of the CO₂ laser bonding.

FIG. 8 is a schematic drawing about the CO₂ laser bonding, describing a relationship between laser beam irradiation by the CO₂ laser and bonding of polyimide films.

FIG. 9 is a photographic copy of a bonding part between polyimide films bonded by the hot plate bonding, taken from a front side of the films by an optical microscope.

FIG. 10 is a photographic copy of a bonding part between polyimide films bonded by the CO₂ laser bonding, taken from a front side of the films.

FIG. 11 is a photographic copy of a cross section of a bonding part between polyimide films, taken by a scanning electron microscope.

FIG. 12 is a photographic copy of a thermally decomposed polyimide film, taken by an optical microscope.

FIG. 13 is a photographic copy showing the state of polyimide films irradiated with a laser beam from the CO₂ laser, at a drawing speed of 37.9 mm/min, at 2.4 W (40 W, output 6%), with a defocus distance being increased from 0 mm to 10 mm.

FIG. 14 is a schematic drawing showing a relationship between a spot size of the laser beam and a defocus distance.

FIG. 15 is a photographic copy of an airbag produced by bonding of polyimide films by the bonding method according to the present invention.

FIG. 16 is a plan view of a test specimen composed of two polyimide films bonded to each other, as used in a peel test in Examples.

FIG. 17 is a plan view of the polyimide films before test specimens used in the peel test in Examples were cut out.

FIG. 18 is a schematic drawing that describes the peel test in Examples.

FIG. 19 is a front view of a tensile testing machine used in the peel test in Examples.

FIG. 20 is a graph showing an example of a relationship between a tensile stroke and a generated force, measured in the peel test in Examples.

FIG. 21 shows photographic copies each indicating a measurement position of a mold surface temperature, in thermographic measurement of the mold surface temperature in the device shown in FIG. 1 and FIG. 2.

FIG. 22 is an explanatory illustration about the CO₂ laser bonding, showing a relationship between a set speed of the laser beam and a bonding part drawing speed in arc-like laser beam irradiation.

FIG. 23 is an explanatory illustration about the CO₂ laser bonding, showing a relationship between a set speed of the laser beam and a bonding part drawing speed in zigzag laser beam irradiation.

FIG. 24 is a graph showing the results of a CO₂ laser bonding test, conducted at various laser outputs, at various bonding part drawing speeds.

FIG. 25 is a graph showing the results of a CO₂ laser bonding test, conducted at various laser outputs, with various types of heat insulator.

FIG. 26 is a graph showing the results of a CO₂ laser bonding test (arc-like irradiation), conducted at various laser outputs, with various widths of a strip-shaped bonding part.

FIG. 27 is a graph showing the results of a CO₂ laser bonding test (zigzag irradiation), conducted at various laser outputs, with various widths of a strip-shaped bonding part.

FIG. 28 is a schematic front view showing an example of a method for bonding a polyimide film to a metal.

FIG. 29 is a photographic copy showing a bonding part (bonding along a mold shape) where a polyimide film was bonded to a duralumin (A2017).

FIG. 30 is a photographic copy showing a bonding part (bonding across the entire film surface) where a polyimide film was bonded to a duralumin (A2017).

FIG. 31 is a photographic copy showing a bonding part where a polyimide film was bonded to a stainless steel (SUS430).

### DESCRIPTION OF EMBODIMENTS

The present invention covers a polyimide film bonding method, a bonding device, and a bonded structure having a polyimide film bonding part, which will be described below. In an embodiment, bonding is defined as joining of polyimide films that were previously spaced from each other, whereby the polyimide films are joined in direct contact with each other. In another embodiment, bonding is defined as joining of a polyimide film and a metal that were previously spaced from each other, whereby the polyimide film and the metal are joined in direct contact with each other.

### <Polyimide Film>

Polyimide is an organic polymer obtained by condensation polymerization of a dianhydride and a diamine. Being highly heat resistant and highly insulative, aromatic polyimides have attractive properties, in particular, as a material for items to be used in extreme environments hardly accessible by humans, such as in the space environment, the high-temperature environment, the extremely low-temperature environment, and acidic/alkaline solutions.

The aromatic polyimides generally melt at very high temperatures. It is often the case that their melting points are close to their thermal decomposition temperatures or that their melting points are difficult to identify (as mentioned above and as will be mentioned below, “a polyimide whose melting point is close to its thermal decomposition temperature or whose melting point is difficult to identify” is called “difficult-to-melt polyimide”). An attempt to melt such polyimides by heating results in pore formation or carbonization, and hence thermal bonding (welding) of such polyimides was considered impossible.

The bonding method according to the present invention enables direct bonding of one or more difficult-to-melt polyimide films. In other words, one or more polyimide films that has/have not undergone chemical modification such as introduction of thermoplastic segments can be bonded without pretreatment or without using an adhesive agent. As described in First to Third Embodiments below, this bonding method does not require any complex/special step or production device, and can increase the production easily.

Although the bonding method according to the present invention may also be applied to polyimide films other than the difficult-to-melt polyimide film(s), the bonding method according to the present invention is particularly applied to the difficult-to-melt polyimide film(s). As for the physical properties of the difficult-to-melt polyimide film(s), the melting point and the thermal decomposition temperature are both 400° C. or higher, and the melting point and the thermal decomposition temperature are close or identical to each other.

The bonding method according to the present invention is applied to the difficult-to-melt polyimide film(s) each having a glass transition temperature of preferably from not lower than 200° C. to not higher than 450° C., more preferably from not lower than 220° C. to not higher than 450° C., and particularly preferably from not lower than 250° C. to not higher than 420° C. The glass transition temperature of the difficult-to-melt polyimide film(s) is measured by differential scanning calorimetry (DSC).

The bonding method according to the present invention is applied to the difficult-to-melt polyimide film(s) each having a thermal decomposition temperature of preferably 550° C. or higher, more preferably 580° C. or higher, and particularly preferably 600° C. or higher. To be more specific, the thermal decomposition temperature is preferably from not lower than 550° C. to not higher than 900° C., more preferably from not lower than 580° C. to not higher than 850° C., and particularly preferably from not lower than 600° C. to not higher than 800° C. The thermal decomposition temperature of the difficult-to-melt polyimide film(s) is measured by thermogravimetric analysis (PGA).

The bonding method according to the present invention is applied to the difficult-to-melt polyimide film(s) that melt(s) at a very high temperature and hence whose melting point is close to its/their thermal decomposition temperature, or is applied to the difficult-to-melt polyimide film(s) that melt(s) at a high temperature close to its/their thermal decomposition temperature and hence whose melting point is difficult to identify. Each difficult-to-melt polyimide film has a melting point of preferably 480° C. or higher, more preferably 500° C. or higher, and particularly preferably 530° C. or higher. To be more specific, the melting point is preferably from not lower than 480° C. to not higher than 600° C., more preferably from not lower than 500° C. to not higher than 600° C., and particularly preferably from not lower than 530° C. to not higher than 595° C. The melting point of the difficult-to-melt polyimide film(s) is measured by differential thermal analysis (DTA).

The bonding method according to the present invention is applied to the difficult-to-melt polyimide film(s) such as a polyimide film containing a polyimide that has a repeating unit represented by following Formula (1), and a polyimide film containing a polyimide that has a repeating unit represented by following Formula (2).

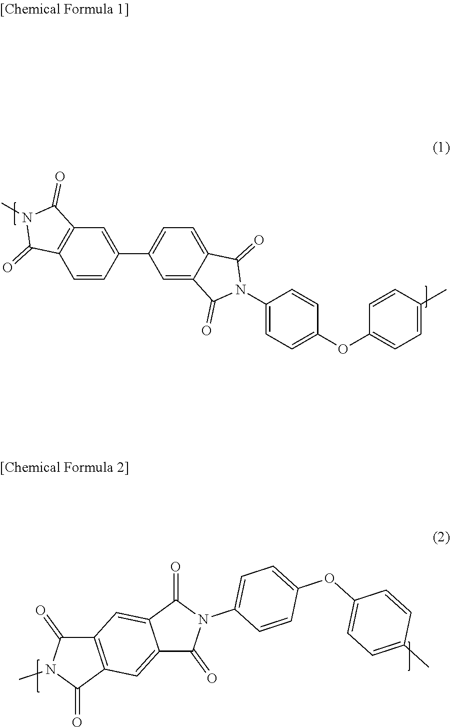

The polyimide film containing the polyimide that has the repeating unit represented by above Formula (1) includes “UPILEX®” manufactured by UBE Corporation.

The polyimide film containing the polyimide that has the repeating unit represented by above Formula (2) includes “KAPTON®” manufactured by DuPont de Nemours, Inc. and “APICAL®” manufactured by KANEKA CORPORATION.

The bonding method according to the present invention is applied to the polyimide film(s) whose thickness is not particularly limited. Having said that, the film thickness is preferably from not less than 12.5 m to not more than 125 m, more preferably from not less than 12.5 m to not more than 75 m, and particularly preferably from not less than 25 m to not more than 50 m.

### First Embodiment: Hot Plate Bonding Between Polyimide Films

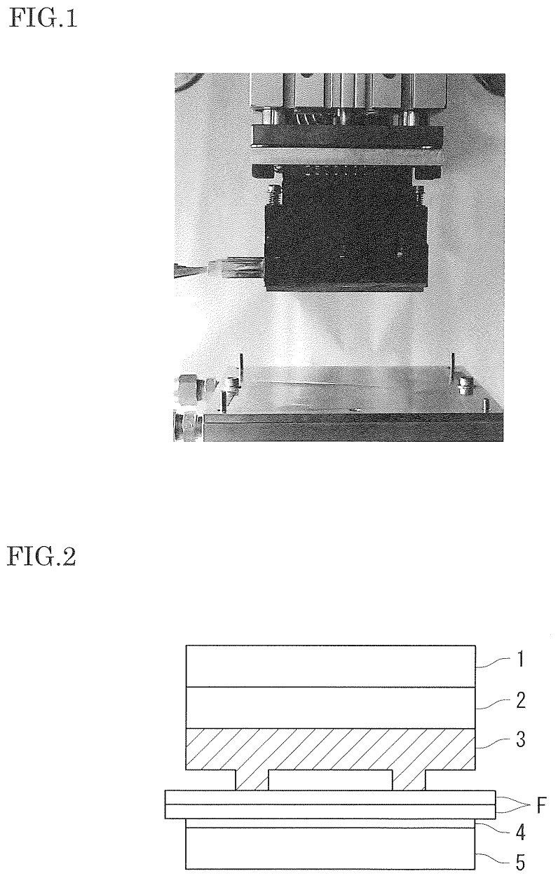

First Embodiment of the present invention relates to hot plate bonding between polyimide films. FIG. 1 is a photographic copy showing a device that may be used in hot plate bonding. FIG. 2 is a schematic front view showing an example of the hot plate bonding. Following description is made with reference to these drawings.

In First Embodiment of the present invention, polyimide films F are bonded to each other in the following manner, for example, as shown in FIG. 2. A silica cloth 4 and two polyimide films F are superposed on a support member 5 (see a bottom part of the photograph in FIG. 1). A mold 3 is heated by a heater 2 to a high temperature and serves as a hot plate. The heated mold 3 is brought into contact with the polyimide films F for a short time, and causes the polyimide films F to be bonded to each other. Preferably, the support member 5 is a cold-water plate.

The manner for bringing the hot plate into contact with the polyimide films for a short time is not particularly limited in the present invention. The hot plate may establish the contact from a bottom surface of the superposed polyimide films, from both top and bottom surfaces of the superposed polyimide films, or from between the two polyimide films. In the device shown in the photograph of FIG. 1, a support member 1 that supports the heater 2 and the mold 3 is provided with a cylinder, as shown in a top part of the photograph. This cylinder presses the mold 3 (the hot plate) against the polyimide films F for a short time to effect the bonding between the polyimide films F.

The hot plate bonding method of First Embodiment bonds two polyimide films to each other by bringing the hot plate into contact with a portion where the two polyimide films are superposed. This method is characterized in that a heating temperature by the contact with the hot plate is 450° C. or higher, and that a contact time between the polyimide films and the hot plate is 12 seconds or less. In the case of FIG. 2, this means that the temperature of the mold 3 is 450° C. or higher, and that the contact time between the polyimide films F and the mold 3 is 12 seconds or less.

In general, hot plate bonding encompasses contact bonding in which one or more films and a hot plate are allowed to contact with each other, and non-contact bonding in which one or more films are heated by radiation heat from a hot plate. The hot plate bonding method according to the present invention may adopt non-contact bonding if the films can be heated to as high as the above-mentioned temperature achieved by the contact with the hot plate. Having said that, contact bonding is preferable because the films need to be heated to a considerably high temperature.

In the hot plate bonding method according to the present invention, the heating temperature by the contact with the hot plate is preferably higher than the glass transition temperature of the polyimide films to be bonded, and is preferably close to the thermal decomposition temperature of the polyimide films. Although variable with the type of difficult-to-melt polyimide films to be bonded, the heating temperature for bonding the difficult-to-melt polyimide films is preferably from not lower than 500° C. to not higher than 700° C., more preferably from not lower than 530° C. to not higher than 680° C., and particularly preferably from not lower than 540° C. to not higher than 660° C. Note that these temperature ranges indicate a set temperature for the heater that heats the hot plate, and can be converted to temperature ranges for the hot plate, based on measurement results in “Measurement of the relationship between the mold surface temperature and the heater set temperature, in the hot plate bonding test” (Table 11) in Examples to be mentioned below. Thus converted, the approximate temperature ranges for the hot plate are preferably from not lower than 450° C. to not higher than 650° C., more preferably from not lower than 480° C. to not higher than 630° C., and particularly preferably from not lower than 490° C. to not higher than 610° C. The suitable temperature ranges for heating the polyimide films are similar when the hot plate is a conductive member (mold-heater integrated type) as described below.

For the polyimide film containing the polyimide that has the repeating unit represented by above Formula (1), the heating temperature resulting from the contact between the hot plate and the polyimide films is preferably from not lower than 520° C. to not higher than 570° C. (the approximate temperature range for the hot plate is not lower than 470° C. to not higher than 520° C., as similarly converted according to Table 11), and more preferably from not lower than 540° C. to not higher than 560° C. (the approximate temperature range for the hot plate is not lower than 480° C. to not higher than 510° C., as similarly converted according to Table 11). The heating temperature within the above ranges ensures firmer bonding between the polyimide films.

For the polyimide film containing the polyimide that has the repeating unit represented by above Formula (2), the heating temperature resulting from the contact between the hot plate and the polyimide films is preferably from not lower than 590° C. to not higher than 650° C. (the approximate temperature range for the hot plate is not lower than 530° C. to not higher than 600° C., as similarly converted according to Table 11). The heating temperature within the above ranges ensures firmer bonding between the polyimide films.

In the hot plate bonding method according to the present invention, the contact time between the polyimide films and the hot plate is 12 seconds or less. The contact time is preferably 6 seconds or less, more preferably 5 seconds or less, further preferably from not less than 0.3 seconds to not more than 3 seconds, and particularly preferably from not less than 0.5 seconds to not more than 1.5 seconds.

In the hot plate bonding method according to the present invention, the hot plate is brought into contact with the polyimide films, preferably in such a manner as to apply a contact pressure to the polyimide films. The contact pressure is preferably about 100 kPa. To be more specific, the contact pressure is preferably from not less than 50 kPa to not more than 200 kPa, and more preferably from not less than 75 kPa to not more than 150 kPa. The contact pressure within the above ranges ensures firmer bonding between the polyimide films.

In the hot plate bonding method according to the present invention, the hot plate may be a mold connected to the heater as shown in FIG. 1 and FIG. 2, or may be a mold integrated with the heater. The material for the mold is not particularly limited as far as being heatable to a high temperature and being capable of transmitting heat to the films to be bonded. For example, the mold may be metallic, and may be preferably made of iron, copper, or silver. The shape of the mold is not particularly limited, and may be made in various shapes. For example, a mold may have a protrusion provided in accordance with a portion to be bonded, may have a flat plate-like shape, or may have a string-like shape formed by application of printed electronics to be described below.

In the hot plate bonding method according to the present invention, a conductive member may be used as the mold integrated with the heater. While the conductive member has been kept in contact with the polyimide films in a tightly attached manner under the contact pressure, the conductive member is heated instantaneously by application of a voltage to the conductive member, and is thereby allowed to serve as the hot plate.

For example, as shown in FIG. 4, a silica cloth 4 and two polyimide films F are superposed on a sandwiching member 8, and a conductive member 7 and the polyimide films F are sandwiched between a sandwiching member 6 and the sandwiching member 8 in a tightly attached manner. This arrangement keeps the conductive member 7 and the polyimide films F in contact with each other under the contact pressure. In this state, the conductive member 7 is heated instantaneously by application of a voltage, so that the conductive member can serve as the hot plate for a short time and can effect bonding between the polyimide films F.

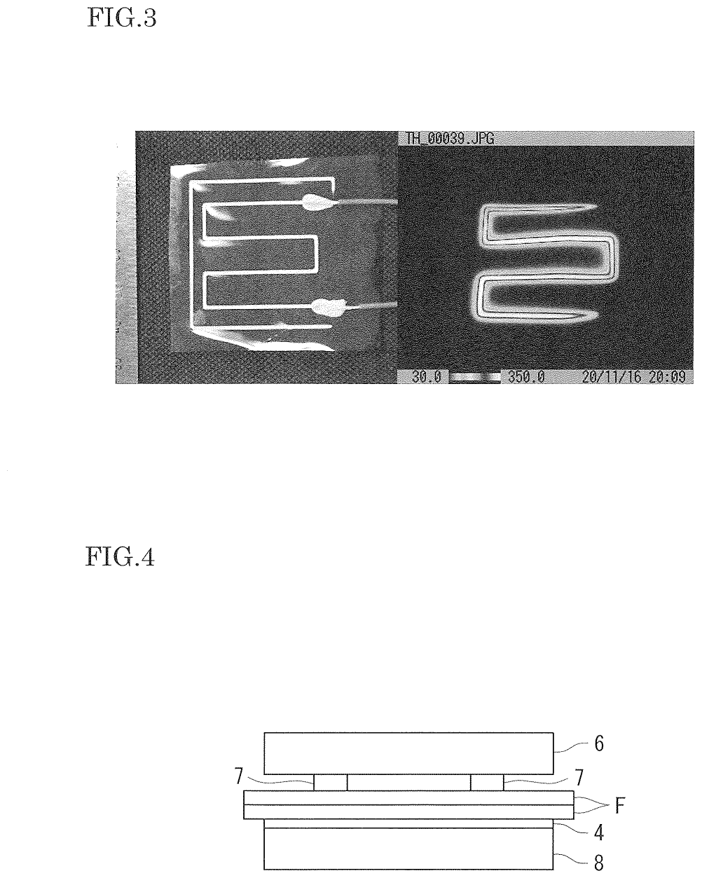

The heater-integrated mold includes an electrode (a conductive member) formed by application of printed electronics, as shown in FIG. 3. Printed electronics enables manufacture of molds having various shapes in a short time and in a simple manner.

### Second Embodiment: Laser Bonding Between Polyimide Films

Second Embodiment of the present invention relates to laser bonding between polyimide films.

A currently dominant laser welding method uses a laser transmitting resin and a laser absorbing resin in combination. This laser welding is conducted by irradiating “only” the laser absorbing resin with a laser beam to heat/melt the laser absorbing resin, and causing the laser transmitting resin to heat/melt by that heat. A CO₂ laser, which emits a laser beam absorbed by a wide range of resins, is not usually used in laser welding. However, the present inventors have found that a CO₂ laser that emits a laser beam highly absorbed by resins is suitable for the bonding between polyimide films in which high-temperature heating is required.

As another obstacle to laser bonding, polyimide films have some problems with laser irradiation, and may be, for example, carbonized by laser beam irradiation or perforated by laser beam irradiation. Hence, it was conventionally thought that laser bonding of polyimide films was difficult. However, the present inventors have made creative efforts to irradiate the top surface of the superposed polyimide films with a laser beam, by tightly attaching a heat insulator to the bottom surface of the polyimide films under a laser beam irradiation position, and thereby allowing the polyimide films heated by the laser beam to retain the heat inside themselves. Through their efforts, the present inventors have found that the polyimide films can be heated up to a bondable temperature by laser beam irradiation, even at an output that does not cause carbonization of the polyimide films.

Specifically, the laser bonding method according to the present invention bonds two polyimide films to each other by irradiating, with a laser beam, a portion where the two polyimide films are superposed. This method is characterized in that a top surface of the superposed polyimide films is irradiated with a laser beam while a bottom surface of the superposed polyimide films is kept tightly attached to a heat insulator.

The laser in this bonding method may be the CO₂ laser as mentioned above or may be other lasers. For example, the present inventors have confirmed that the difficult-to-melt polyimide films can be bonded to each other by means of a UV diode laser. Use of a diode laser can reduce the size of the bonding device.

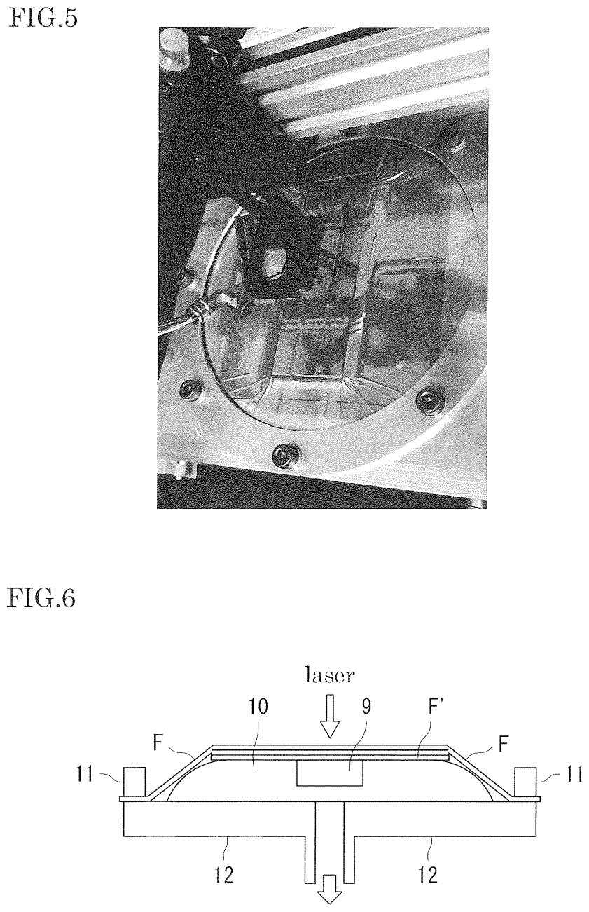

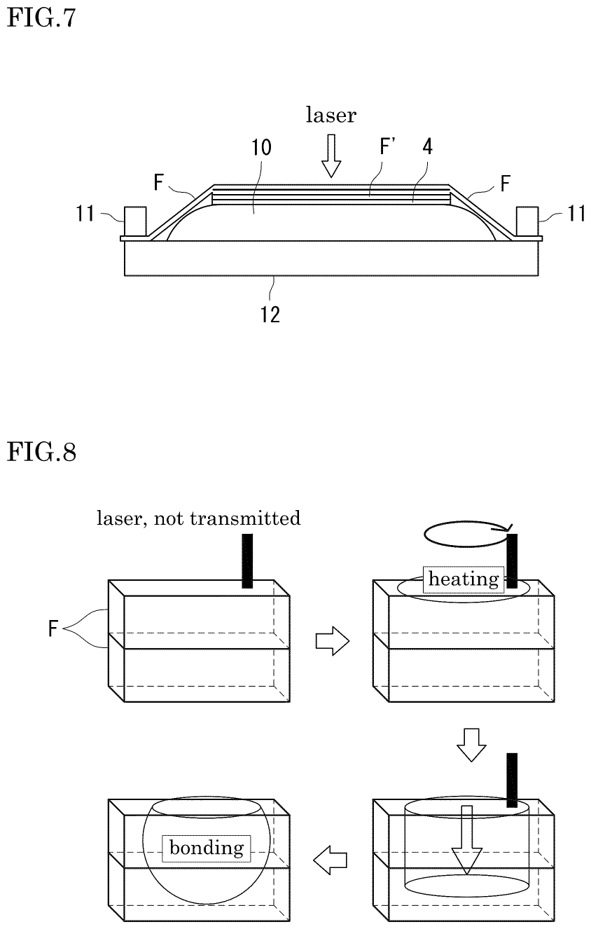

To tightly attach the heat insulator to the bottom surface (the surface opposite to the one irradiated with a laser beam) of the polyimide films in the laser bonding method according to the present invention, a silica cloth may be tightly attached as the heat insulator, or a vacuum layer may be provided as the heat insulator, to give a few examples. The bonding device shown in FIG. 5 and FIG. 6 is configured to tightly attach a vacuum layer to the bottom surface of the polyimide films. The bonding device shown in FIG. 7 is configured to tightly attach a silica cloth to the bottom surface of the polyimide films. FIG. 5 is a photographic copy showing a device used to conduct CO₂ laser bonding. FIG. 6 and FIG. 7 are schematic front views showing examples of the CO₂ laser bonding. The bonding devices are hereinafter described with reference to these drawings.

The bonding device shown in FIG. 5 and FIG. 6 includes a support member 10 that supports the bottom surface of the polyimide films F, and a CO₂ laser emission part (see the photograph of FIG. 5) that emits a laser beam onto the polyimide films F. The support member 10 has an insulating layer at a position to be in contact with the bottom surface of the polyimide films F. The insulating layer has a surface layer to be in contact with the polyimide films F, and a vacuum layer 9 placed under the surface layer. The surface layer is formed by a thermosetting polyimide film F′. The two polyimide films F to be bonded are held in a sandwiched manner between sandwiching members 11 and 12, and thereby tightly attached to the support member 10. A laser beam is emitted onto these polyimide films F to conduct the laser bonding method according to the present invention.

In the bonding device shown in FIG. 6, the thermosetting polyimide film F′ is provided on the support member 10 that has a recess. The recess is depressurized by a depressurizer to create a vacuum in the vacuum layer 9. For example, the device shown in FIG. 5 is configured to have a grooved bottom plate under the thermosetting polyimide film F′, to reduce the pressure around the bottom plate by the depressurizer to create a vacuum in the groove space, and to emit a laser beam along the groove.

The degree of vacuum in the vacuum layer 9 may be designed to ensure a heat insulation effect sufficient for allowing the polyimide films heated by the laser beam to retain the heat inside themselves. To be specific, the degree of vacuum in the vacuum layer 9 is preferably 150 hPa or less, more preferably 130 hPa or less, and particularly preferably 110 hPa or less.

The bonding device shown in FIG. 7 includes a support member 10 that supports the bottom surface of the polyimide films F, and a laser emission part that emits a laser beam onto the polyimide films F. On the surface of the support member 10, a silica cloth 4 serving as the heat insulator and a thermosetting polyimide film F′ are laminated in this order. Two polyimide films F to be bonded are laid on the thermosetting polyimide film F′, held in a sandwiched manner between sandwiching members 11 and 12, and thereby tightly attached to the heat insulator. In the state shown in FIG. 7, a laser beam is emitted onto the top surface of the polyimide films F to conduct the laser bonding method according to the present invention. For the bonding operation using the bonding device shown in FIG. 7, the polyimide films F are preferably pulled toward the support member 10 by vacuuming from below the sandwiching member 12, and are thereby tightly attached to the silica cloth 4 as the heat insulator.

When the laser bonding method according to the present invention uses a CO₂ laser, the laser output is, for example, from not less than 2 W to not more than 5 W, and preferably around 3 W.

In the laser bonding method according to the present invention, the laser beam emitted onto the polyimide films is preferably moved in an arc-like path, a polygonal path, or a zigzag path, with the polyimide films to be bonded being displaced from the focal point of the laser beam.

The greater the spot size of the laser beam is, the lower the power density. The present inventors assumed that carbonization or pore formation by laser bonding would occur when the power density of the laser beam was greater than required. Based on this assumption, the present inventors have found that laser bonding can be conducted without carbonization or pore formation, by displacing the polyimide films from the focal point of the laser beam, increasing the spot size, and reducing the power density.

When the laser bonding method according to the present invention uses a 2.4-watt CO₂ laser beam (a CO₂ laser at 40 W, output 6%), the defocus distance that enables bonding without carbonization is, for example, from not less than 5 mm to not more than 15 mm, preferably from not less than 6 mm to not more than 12 mm, and more preferably from not less than 7 mm to not more than 10 mm. The definition of the defocus distance will be given in the section of Examples.

Since the laser beam emitted from the CO₂ laser does not pass through the polyimide films (see the top left illustration in FIG. 8), the laser beam emitted in an arc-like path or a polygonal path (see the top right illustration in FIG. 8) can heat the polyimide films evenly as far as the inside (see the bottom right illustration in FIG. 8). It is thus possible to bond the polyimide films to each other while avoiding carbonization and pore formation.

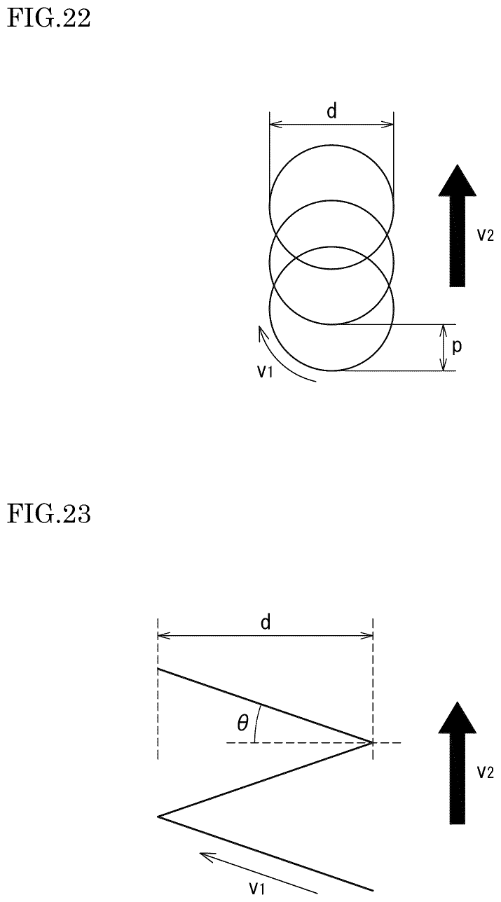

As shown in FIG. 22, a laser beam may draw a strip-shaped bonding part with a width d, when emitted to draw circles with a diameter d and to advance in a given direction. Suppose that the speed of advance of the laser beam (the set speed of the laser processing machine) is v₁, and that the pitch of displacement of each circle is p, then the time taken to draw a full circle is expressed as t₁=πd/v₁. Accordingly, the bonding part drawing speed v₂ can be calculated as v₂=p/t₁=pv₁/πd.

As shown in FIG. 23, a laser beam emitted in a zigzag path can also heat the polyimide films evenly as far as the inside, and allows the bonding between the polyimide films without carbonization or pore formation. Also in this case, the bonding part drawing speed v₂ can be calculated from the angle θ, the width d of the strip-shaped bonding part, and the speed of advance of the laser beam v₁ shown FIG. 23.

In the following description, the term “arc-like irradiation” means the laser beam irradiation as shown in FIG. 22, wherein the laser beam is emitted to draw circles and advance in a given direction, and thereby draws a strip-shaped bonding part. The term “zigzag irradiation” means the laser beam irradiation as shown in FIG. 23, wherein the laser beam is emitted in a zigzag path and thereby draws a strip-shaped bonding part. The width d of the strip-shaped bonding part may also be called line width.

### <Polyimide Film Having a Bonding Part>

The polyimide film bonding method according to the present invention can realize a polyimide film that has a bonding part where the difficult-to-melt polyimide films are bonded to each other. The polyimide film bonding method according to the present invention can also provide the bonding part with a bonding strength of 50 N/m or greater.

To be specific, two polyimide films to be bonded are a first polyimide film and a second polyimide film, and each of the first and second polyimide films is either “the polyimide film containing the polyimide that has the repeating unit represented by above Formula (1)” or “the polyimide film containing the polyimide that has the repeating unit represented by above Formula (2)”. Even in this case, the present bonding method can bond these polyimide films directly to form a bonding part, or in other words, can manufacture a polyimide film having this bonding part.

Accordingly, the polyimide film having the bonding part of the present invention is not only lightweight, but also has excellent heat resistance, cold resistance, and radiation/ultraviolet resistance that enable its use in extreme environments like the cosmic space that experiences the extremely low-temperature environment and the extremely high-temperature environment.

Owing to the above-mentioned characteristics, the polyimide film having the bonding part of the present invention can be applied to an extreme environment-oriented robot or the like configured by a film-only skeleton structure or actuator. To mention some features of such a robot, the robot is extremely lightweight because of its film-only actuator, can be produced at a low cost on a large scale, is rollable and foldable for compact storage, can produce a unit capable of changing the stiffness or memorizing the shape, and can create a new motion owing to its high-aspect-ratio and extremely lightweight design (can make effective use of its size effect).

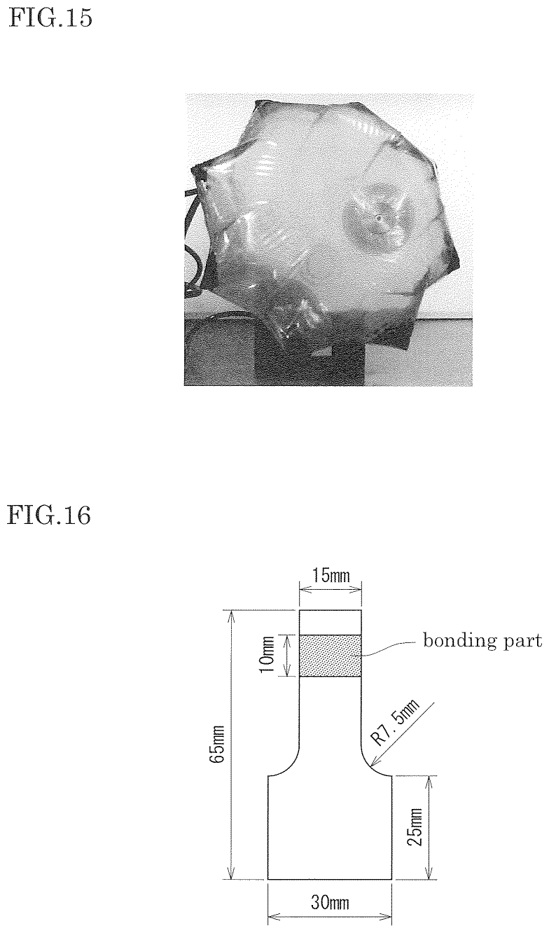

The polyimide film bonding method according to the present invention can further realize a bag body without including any adhesive agent or fixing metal part, for example, by bonding outer edges of the polyimide films to each other. The bag body may be an airbag shown in FIG. 15, which is suitable as an impact attenuator against a fall of a flying object or other impact or suitable for use in extreme environments like the cosmic space. The airbag shown in FIG. 15 is manufactured of the difficult-to-melt polyimide films only, wherein peripheral portions of two superposed difficult-to-melt polyimide films are bonded by the bonding method according to the present invention, and air or other gas is charged in a non-bonded central portion between the films.

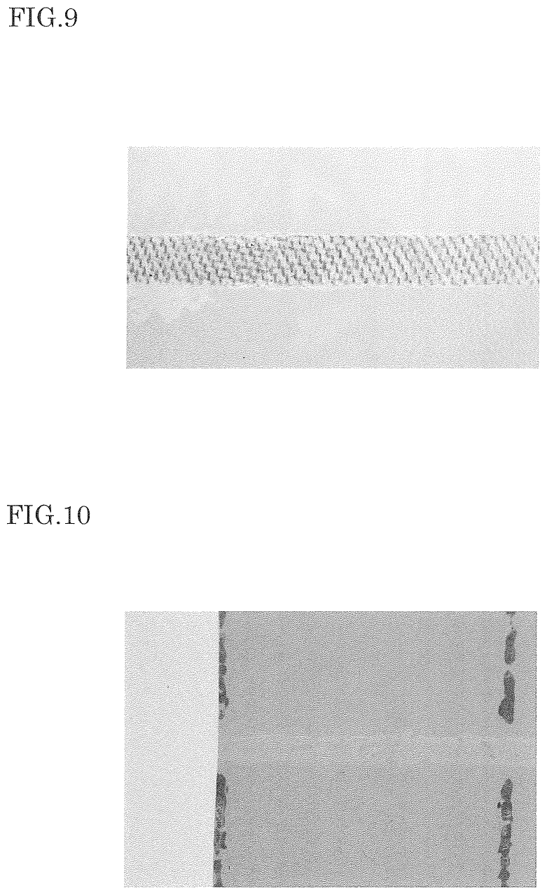

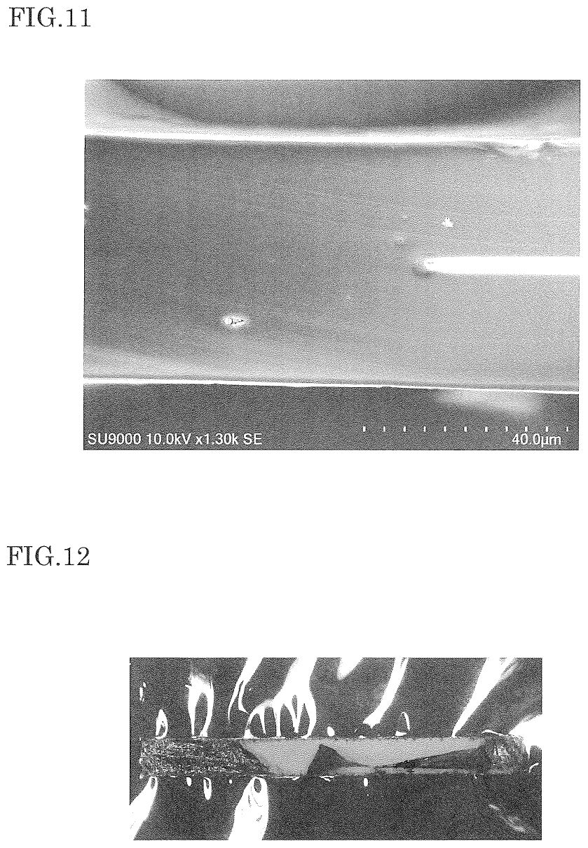

FIG. 9 is a photographic copy showing a polyimide film bonding part between the polyimide films bonded to each other by the hot plate bonding, taken from a front side of the films by an optical microscope. A horizontal strip-shaped bonding part is visible in FIG. 9. The pattern in the bonding part represents a color change in the polyimide films that developed along a fabric pattern of the silica cloth 4 when the mold 3 (the hot plate) shown in FIG. 2 was pressed against the polyimide films. FIG. 10 is a photographic copy of a polyimide film bonding part (2 mm wide, strip-shaped) between the polyimide films bonded to each other by the CO₂ laser bonding, taken from a front side of the films. The photograph of FIG. 10 was taken by a single-lens reflex camera with a macro lens attached. A horizontal strip-shaped bonding part is visible in the photograph of FIG. 10. FIG. 11 is a photographic copy showing a cross section of a bonding part between the polyimide films (product name: APICAL 25NPI, manufactured by KANEKA CORPORATION, film thickness 25 μm) bonded to each other by the hot plate bonding, taken by a scanning electron microscope (Type: SU9000, manufactured by Hitachi High-Tech Corporation). The vertical direction in the photograph corresponds to a thickness direction of the bonded polyimide films. Bonded surfaces are in a central part thereof. A white area along the bonded surfaces, seen on the right side of the photograph, represents a non-bonding part (where no bonding operation was effected), and a left part to the white area corresponds to the bonding part where the bonding operation was effected. As confirmed by FIG. 11, the films were bonded without a gap at the bonding part. In other words, the bonding method according to the present disclosure can bond the polyimide films directly to each other, as confirmed by the photographs in FIG. 9 to FIG. 11.

### Third Embodiment: Bonding of a Polyimide Film to a Metal

Third Embodiment relates to bonding of a polyimide film to a metal.

As described above, thermal bonding of the difficult-to-melt polyimide was considered impossible. However, the present inventors have succeeded in bonding polyimide films to each other in First Embodiment above. Further, instead of bonding the polyimide films to each other, the present inventors have found it possible to bond a difficult-to-melt polyimide film directly to a metal by heating the polyimide film while a contact pressure is applied such that the polyimide film is tightly attached to a surface of the metal.

To be specific, the method for bonding a polyimide film to a metal according to the present disclosure is characterized by heating the polyimide film while a contact pressure is applied such that one surface of the polyimide film is tightly attached to a surface of the metal.

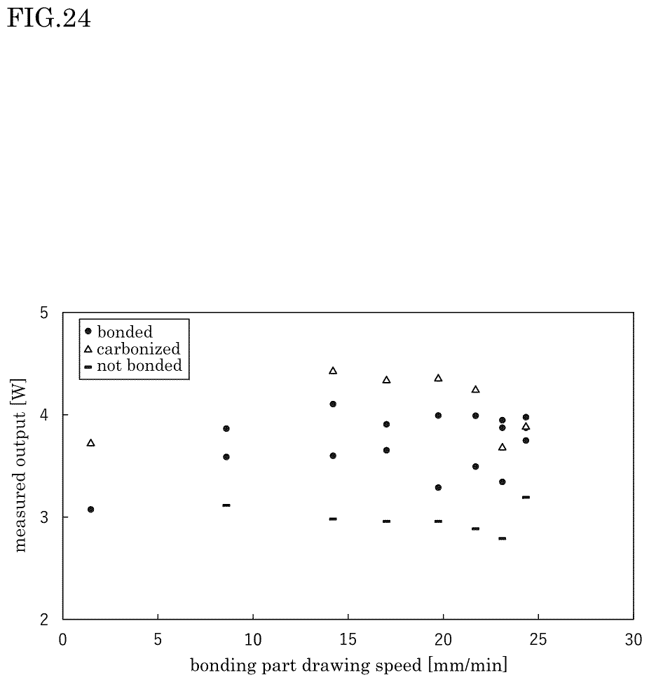

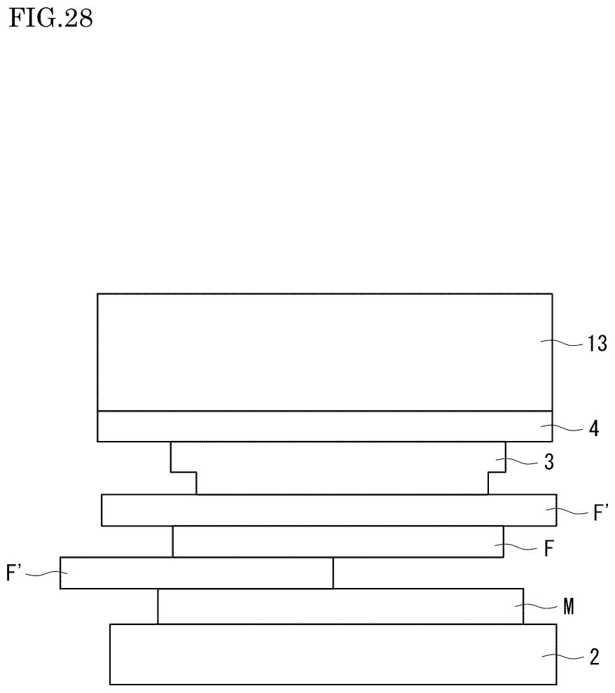

FIG. 28 is a schematic front view showing an example of a method for bonding a polyimide film to a metal. In the example of FIG. 28, a metal M, a polyimide film F, and a thermosetting polyimide film F′ are laminated in this order on a heater 2. On top of the thermosetting polyimide film F′, a mold 3, a silica cloth 4, and a weight 13 are put further in this order. This arrangement applies a contact pressure such that the polyimide film F is tightly attached to the metal M. The thermosetting polyimide film F′ serves to prevent bonding to the polyimide film F, and herein prevents bonding between the polyimide film F and the mold 3. In the example of FIG. 24, another thermosetting polyimide film F′ is partially inserted between the polyimide film F and the metal M, so as to prevent bonding between the polyimide film F and the metal M at the inserted portion.

The polyimide film bonding method according to Third Embodiment can be also implemented in a modified manner, for example, by using the device shown in FIG. 2 that can be used in First Embodiment above, and replacing the bottom one of the superposed polyimide films F with a metal to be bonded.

In Third Embodiment, the polyimide film to be bonded may be heated, for example, at a heating temperature ranging from not lower than 400° C. to not higher than 550° C., for a heating time ranging from not less than 3 minutes to not more than 15 minutes.

The polyimide film bonding method according to Third Embodiment can manufacture a bonded structure that is composed of a polyimide film and a metal and that includes a bonding part where the polyimide film and a surface of the metal are bonded directly.

### Other Embodiments

The embodiments disclosed herein are considered in all respects as illustrative and not restrictive. Therefore, the technical scope of the present invention is indicated by the appended claims rather than by the foregoing embodiments only. Further, all variations and modifications falling within the equivalency range of the appended claims are intended to be embraced in the technical scope of the present invention.

For example, in Embodiments disclosed herein, the superposed polyimide films are set horizontally, and the contact with the hot plate or the laser beam irradiation is effected from the top surface side of the polyimide films. However, the orientation of the polyimide films to be set, the direction of applying the hot plate, and the direction of the laser beam irradiation can be changed suitably.

### EXAMPLES

The present invention is hereinafter described by way of Examples and Comparative Examples. Following Examples, however, are not intended to limit the present invention.

### <Method for the Peel Test of the Polyimide Film Bonding Part>

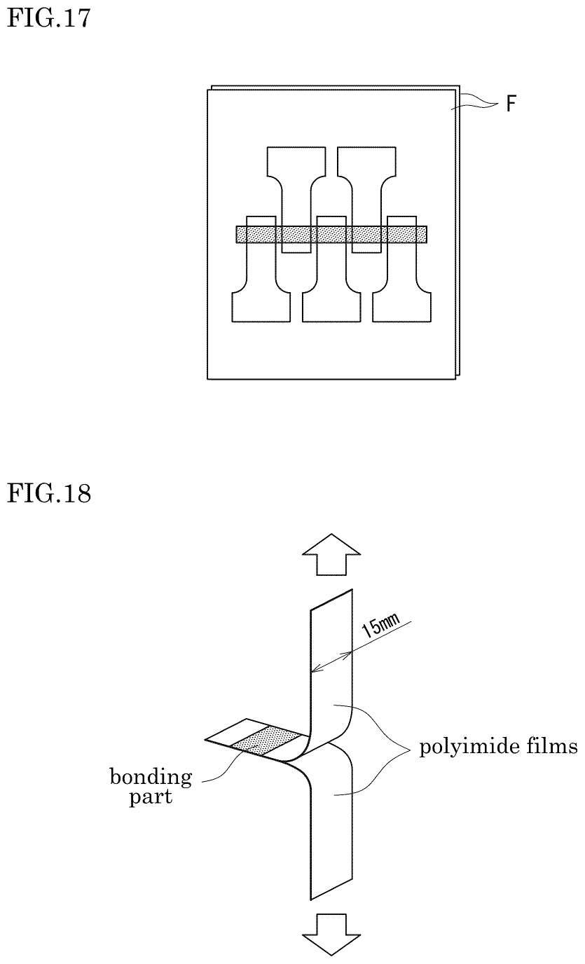

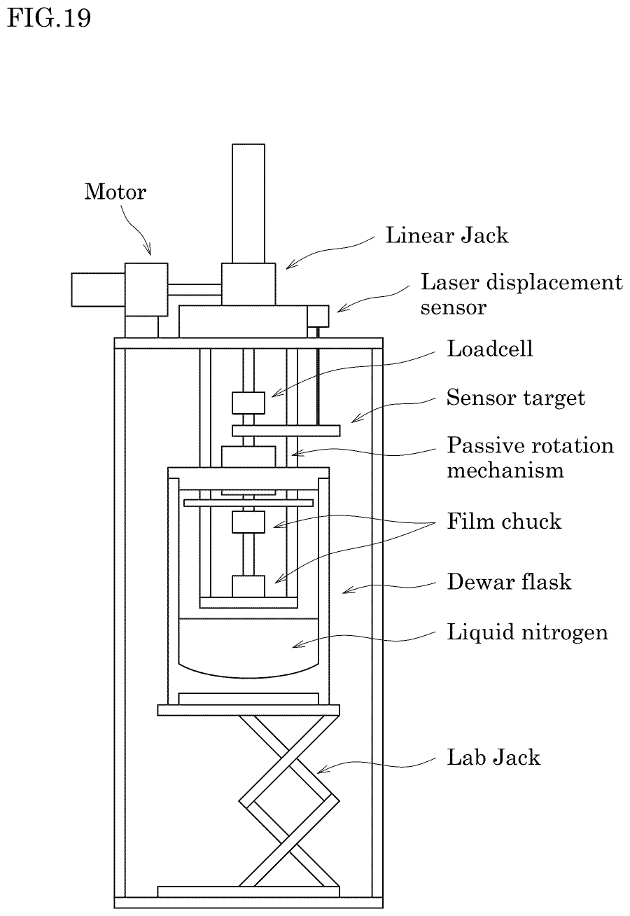

Test pieces having a shape shown in FIG. 16 were cut out from the linearly bonded polyimide films F as shown in FIG. 17. For a T-peel test, each test specimen was peeled open as shown in FIG. 18. FIG. 19 shows a tensile testing machine used in the peel test. The test was conducted at room temperature, without using a liquid nitrogen tank provided in the tensile testing machine. In this tensile testing machine, a test specimen to be peeled was held by a film chuck and subjected to displacement in peeling directions. A reaction force during the displacement was measured.

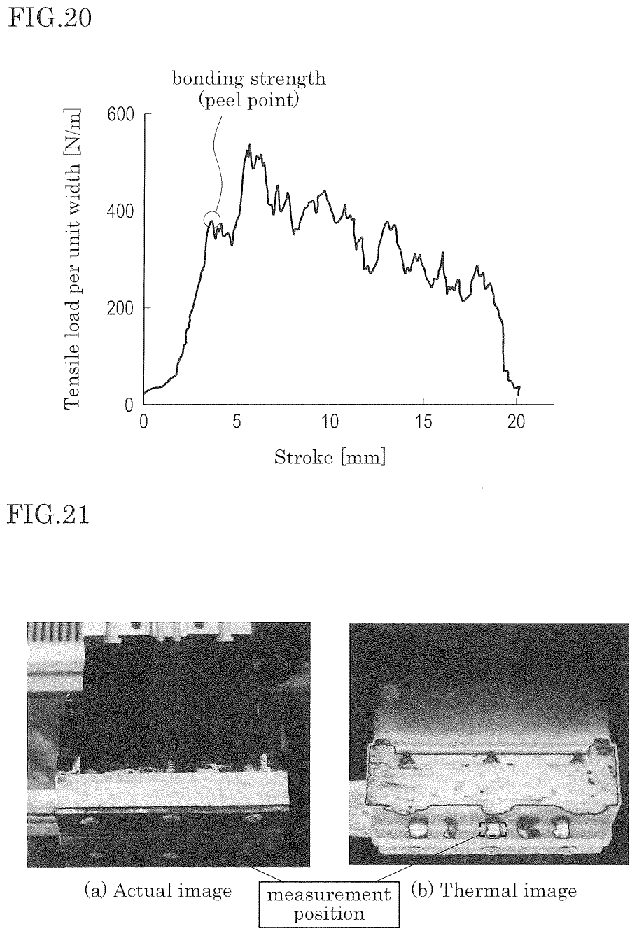

FIG. 20 shows an example of the results, obtained by dividing the measured reaction force by the width (15 mm) of the bonding part in the test specimen. As shown in FIG. 20, the point at which the reaction force dropped drastically for the first time was taken as a peel point (a peeling start point).

### Example 1-1. Hot Plate Bonding Test to UPILEX-25RN

Hot plate bonding was conducted using the device shown in FIG. 1 and FIG. 2. Two polyimide films (product name: UPILEX-25RN, manufactured by UBE Corporation, film thickness 25 μm) were put on a water-cooled plate (corresponding to the support member 5 in FIG. 2) and a silica cloth. The polyimide films were bonded to each other under following conditions. The contact pressure applied to the polyimide films by a hot plate (a heated mold) was 100 kPa. The contact time between the hot plate and the polyimide films was 1 second. The set temperature for the heater was changed, for each test specimen, in a range between 530° C. and 580° C. (or the approximate mold temperature in a range between 480° C. and 530° C., as converted according to Table 11 below). The results are shown in Table 1 below.

TABLE 1

| heating temperature | |
|---|---|
| (° C.) | result of bonding test |
| 530 | failed |
| 540 | succeeded |
| 550 | succeeded |
| 560 | succeeded |
| 570 | succeeded |
| 580 | thermally decomposed |

As evident from Table 1, short-time contact with the highly heated hot plate allowed the difficult-to-melt polyimide films (UPILEX-25RN) to be bonded each other, despite the previous belief that thermal bonding of the difficult-to-melt polyimide films was difficult.

### Example 1-2. Peel Test of Test Specimens that have Bonding Parts Formed by Hot Plate Bonding

The polyimide films (product name: UPILEX-25RN, manufactured by UBE Corporation, film thickness 25 μm) were bonded to each other in a similar manner to Example 1-1, and test specimens were prepared from the bonded polyimide films. A peel test was conducted in the above-described manner. The results are shown in Table 2 below.

TABLE 2

| heating temperature | bonding strength |
|---|---|
| (° C.) | (N/m) |
| 540 | 449.3 |
| 550 | 524.6 |
| 560 | 404.3 |
| 570 | 382.0 |

As evident from Table 2, the test specimens showed sufficient bonding strength when the heating temperature (the set temperature for the heater) was from not lower than 540° C. to not higher than 570° C. (or the approximate mold temperature in a range between 480° C. and 520° C., as converted according to Table 11 below). The highest bonding strength was observed when the heating temperature was 550° C. (or the approximate mold temperature of 500° C., as converted according to Table 11 below).

### Example 1-3. Hot Plate Bonding Test Conducted with Various Contact Times

A bonding test between the polyimide films (product name: UPILEX-25RN, manufactured by UBE Corporation, film thickness 25 μm) was conducted in a similar manner to Example 1-1. The results are shown in Table 3 to Table 7 below, for each heating temperature during the bonding. The bonded state was evaluated by the following criteria.

### —Evaluation Criteria—

A (Excellent): firmly bonded, with no problem
B (Good): firmly bonded, with a slight problem
C (Fair): bonded, peelable by hand by application of force
D (Poor): bonded, easily peelable by hand; or not bonded

TABLE 3
heating temperature: 510° C., contact pressure: 100 kPa

| | | | | | |
|---|---|---|---|---|---|
| contact | 1.4 | 2.4 | 5.6 | 10.3 | 10.7 |
| time [s] | | | | | |
| bonded | D | D | D | C | D |
| state | | | | | |
| state | easily | easily | easily | peelable by | surface |
| | peelable | peelable | peelable | hand; corrugated at | deformed |
| | by hand | by hand | by hand | a portion except | |
| | | | | the bonding part | |
| | | | | (free deformation | |
| | | | | occurred at a | |
| | | | | portion not pressed | |
| | | | | by the mold) | |

TABLE 4
heating temperature: 520° C., contact pressure: 100 kPa

| | | | | |
|---|---|---|---|---|
| contact time [s] | 0.6 | 1.4 | 2.4 | 5.4 |
| bonded state | D | D | D | D |
| state | easily | easily | easily | damaged |
| | peelable | peelable | peelable | by |
| | by hand | by hand | by hand | burning |

TABLE 5
heating temperature: 530° C., contact pressure: 100 kPa

| | | | | |
|---|---|---|---|---|
| contact | 0.7 | 1.2 | 2.4 | 5.4 |
| time [s] | | | | |
| bonded | D | D | C | D |
| state | | | | |
| state | easily | basically easily | weakly bonded; | damaged |
| | peelable | peelable by hand, | partially damaged | by |
| | by hand | partially bonded | by burning/melting, | melting/ |
| | | | small pores formed | burning |

TABLE 6
heating temperature: 540° C., contact pressure: 100 kPa

| | | | | | |
|---|---|---|---|---|---|
| contact time [s] | 0.6 | 1.4 | 2.3 | 5.3 | 10.3 |
| bonded state | C | A | B | D | D |
| bonding strength | — | 525.5 | 531.6 | — | — |
| [N/m] | | | | | |
| state | peelable by hand; due to | bonded relatively | firmly bonded; in the | bonded; surface | damaged by melting/ |
| | the responsiveness of the | firmly; peeled in | peel test, not peeled | melted and | burning; melted specimen |
| | air cylinder for driving, | the peel test | but ruptured at an end | partially damaged | adhering to and lifted |
| | the mold appeared to be | | of the bonding part | by burning | up with the mold; in |
| | removed from the films | | | | other words, could be |
| | after the 0.6-second | | | | bondable to a metal |
| | contact before sufficient | | | | |
| | pressure was applied | | | | |

TABLE 7
heating temperature: 560° C., contact pressure: 100 kPa

| | | | | | |
|---|---|---|---|---|---|
| contact time [s] | 0.6 | 1.3 | 2.4 | 5.4 | 10.4 |
| bonded state | C | A | B | D | D |
| bonding strength | — | 531.7 | 601.87 | — | — |
| [N/m] | | | | | |
| state | bonded, but looked weak; | firmly bonded, not | slightly corrugated around | surface corrugated after | damaged by |
| | the cylinder may have | peelable by hand; | the bonding part; possibly | the bonding; with the | burning, |
| | risen before sufficient | peeled in the peel | deflected by heat; in the | entire films pulled by | pores formed; |
| | pressure was applied | test | peel test, not peeled but | the mold, only the | adhesion of |
| | | | ruptured at an end of the | bonding part was raised | specimen |
| | | | bonding part | | to the mold |

The results shown in Table 3 to Table 7 provide following findings. In a relatively low-temperature region that caused weak bonding, extension of the contact time with the hot plate did not enable bonding of the polyimide films but resulted in thermal deformation of the polyimide films. In other words, these results prove the importance of a short-time contact with a high-temperature hot plate, for the bonding of the difficult-to-melt polyimide films to each other.

The results shown in Table 7 further provide following findings. In the vicinity of the upper limit of a polyimide film-bondable temperature region, extension of the contact time caused following problems. For one, the polyimide films were damaged by burning. For another, the polyimide films adhered to the mold and became unremovable (it is assumed that melted polyimide adhered to the mold). It has also turned out that even the difficult-to-melt polyimide films were deformed by long-time application of heat/pressure. In other words, to bond the difficult-to-melt polyimide films to each other, a shorter contact time can avoid deflection and corrugation of a portion except the bonding part (a hot plate contact portion).

### Example 1-4. Hot Plate Bonding Test to APICAL 25NPI

A bonding test between polyimide films (product name: APICAL 25NPI, manufactured by KANEKA CORPORATION, film thickness 25 μm) was conducted in a similar manner to Example 1-1. The results are shown in Table 8 and Table 9 below. The bonded state was evaluated by the following criteria.

### —Evaluation Criteria—

A (Good): bonded, peelable by hand by application of force
B (Fair): bonded, easily peelable by hand
C (Poor): not bonded

TABLE 8
KANEKA, APICAL 25NPI, 25 μm

| | | | | | | |
|---|---|---|---|---|---|---|
| heating | 300 | 350 | 400 | 450 | 500 | 550 |
| temperature [° C.] | | | | | | |
| contact pressure | 100 | 100 | 100 | 100 | 100 | 100 |
| [kPa] | | | | | | |
| contact time [s] | 1.5 | 1.4 | 1.4 | 1.5 | 1.4 | 1.4 |
| bonded state | C | C | C | C | C | C |
| state | not bonded | not bonded | not bonded | not bonded | not bonded | not bonded |

TABLE 9
KANEKA, APICAL 25NPI, 25 μm

| | | | | | | |
|---|---|---|---|---|---|---|
| heating | 604 | 602 | 597 | 650 | 650 | 650 |
| temperature [° C.] | | | | | | |
| contact pressure | 100 | 100 | 100 | 100 | 100 | 100 |
| [kPa] | | | | | | |
| contact time [s] | 1.4 | 2.4 | 5.4 | 1.4 | 5.5 | 10.4 |
| bonded state | B | A | A | A | A | A |
| bonding strength | — | — | — | 60 | 63 | 95 |
| [N/m] | | | | | | |
| state | bonded, | bonded, | bonded, | bonded more | bonded more | |
| | easily | peelable by | peelable by | firmly than | firmly than the | |
| | peelable | hand; seemingly | hand; seemingly | the 602° C. | 650° C./1.4-sec. | |
| | by hand | no melting and | no melting and | specimen; | specimen; | |
| | | no adhesion | no adhesion | seemingly | seemingly | |
| | | | | no melting | no melting | |

As shown in Table 8 and Table 9, the bonding method according to the present invention can also enable thermal bonding of APICAL 25NPI, which is one of the difficult-to-melt polyimide films for which thermal bonding (welding) was considered impossible.

### Reference Example. Hot Plate Bonding Test to Thermoplastic Polyimide Films

As Reference Example, a bonding test between thermoplastic polyimide films (product name: Midfil, manufactured by Kurabo Industries Ltd., film thickness 25 μm), which are not difficult-to-melt polyimide films, was conducted in a similar manner to Example 1-1. The results are shown in Table 10 below. The bonded state was evaluated by the following criteria.

### —Evaluation Criteria—

A (Good): bonded
B (Poor): not bonded

TABLE 10
Kurabo, Midfil, 25 μm

| | | | |
|---|---|---|---|
| heating temperature [° C.] | 300 | 350 | 400 |
| contact pressure [kPa] | 100 | 100 | 100 |
| contact time [s] | 1.5 | 1.4 | 1.4 |
| bonded state | B | A | B |
| bonding strength [N/m] | — | 676 | — |
| state | not | firmly | ruptured at |
| | bonded | welded | an edge of |
| | | | the mold as |
| | | | if damaged |
| | | | by burning |

### <Measurement of the Relationship Between the Mold Surface Temperature and the Heater Set Temperature, in the Hot Plate Bonding Test>

The heating temperatures given in Tables in Examples 1-1 to 1-4 and Reference Example above were the set temperatures for the heater. For the mold serving as the hot plate, mold surface temperatures were measured at respective set temperatures for the heater. The mold surface temperature was measured by thermography, with blackbody spray (type: JSC-3, emissivity 0.94) being applied to a side surface of the mold 3 shown in FIG. 2. The measurement position of the mold surface temperature is indicated in FIG. 21. When the mold was heated from room temperature by the heater, the mold surface temperature required about 20 minutes to stabilize. Hence, the mold surface temperature was measured at least 20 minutes after the start of the heating by the heater. The relationship between the measured mold surface temperature and the heater set temperature is shown in Table 11.

TABLE 11

| heater set | mold surface temperature, |
|---|---|
| temperature | as actually measured |
| [° C.] | [° C.] |
| 400 | 362 |
| 425 | 378 |
| 450 | 403 |
| 475 | 430 |
| 500 | 453 |
| 525 | 477 |
| 550 | 494 |
| 575 | 521 |
| 600 | 545 |

### Example 2-1. Laser Bonding Test: Conditions for the Defocus Distance

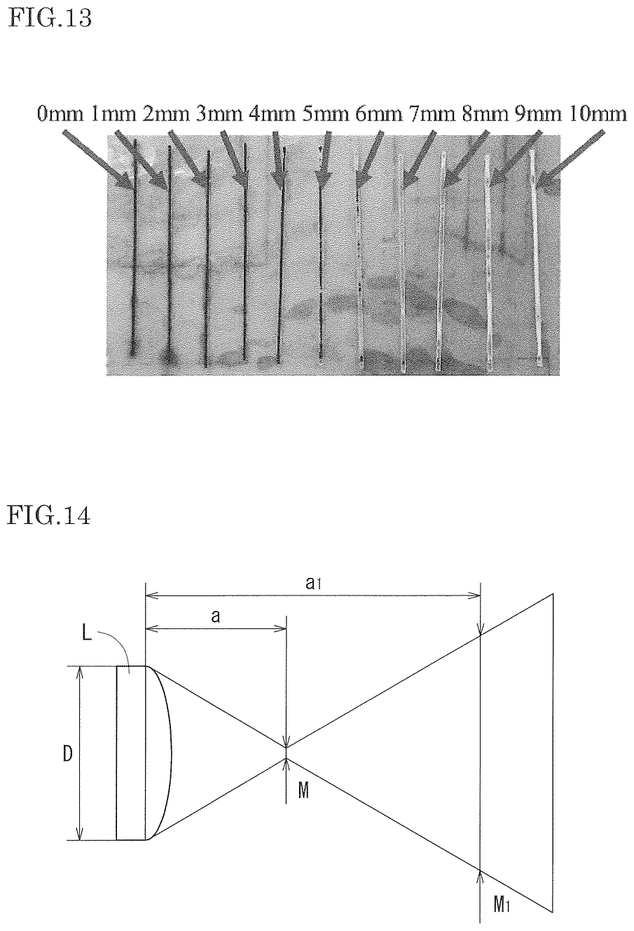

In a CO₂ laser bonding test using the device of FIG. 6 (heat insulator: a vacuum layer), the position of the polyimide films subjected to laser beam irradiation was gradually displaced from the focal point of the laser beam. FIG. 13 shows the state of the polyimide films irradiated with a laser beam (“arc-like irradiation” as shown in FIG. 22) at a bonding part drawing speed of 37.9 mm/min, at 2.4 W (40 W, output 6%), with the defocus distance being gradually increased from 0 mm to 10 mm from the left. The defocus distance as used herein means a distance of displacement of the polyimide films to be bonded, displaced from the focal point of the laser beam toward a lens (a lens provided in the CO₂ laser emission part). When the polyimide films were set at the focal point (when the defocus distance was 0 mm), the polyimide films were carbonized by the laser beam irradiation. As the defocus distance was increased gradually and reached 6 mm, an area where the surface of the polyimide films was modified without carbonization showed an increase. When the defocus distance was 7 mm to 10 mm, it is seen that the polyimide films could be bonded with hardly any carbonization.

FIG. 14 shows a relationship between a spot size of the laser beam and the defocus distance, where D represents a diameter of the lens L, a represents a focal length, M represents a spot size of the laser beam, a₁ represents a distance from the lens L to a material to be bonded (the distance after defocusing), and M₁ represents a spot size of the laser beam at a position of the material to be bonded. Then, M₁ can be calculated by following Formula (3).

$$\begin{matrix}[ Mathematical formula 1 ] & \\ {M}_{1} = \frac{{a}_{1}}{a} ( M + D ) - D & ( 3 )\end{matrix}$$

The lens L used in this Example had a diameter (D) of 20 mm, a focal length (a) of 50.8 mm, a thickness of 2 mm, and a spot size of the laser beam (M) of about 0.2 mm. When the defocus distance is 10 mm, a₁=60.8 mm. With these values being substituted into Formula (3) above, the spot size of the laser beam M₁ during the bonding can be calculated as about 4.2 mm (M₁=about 4.2 mm). Similar calculation at the defocus distance of 7 mm gives M₁=about 3.0 mm. From these results, it is understood that the bonding with hardly any carbonization is possible when the spot size of the laser beam during the bonding is in a range of 3 mm to 4.2 mm.

### Example 2-2. Laser Bonding Test: Conditions for the Laser Output

A CO₂ laser bonding test in which the polyimide films to be bonded were irradiated with a laser beam was conducted at various laser outputs, at various bonding part drawing speeds. The circles as shown in FIG. 22 were drawn by the arc-like irradiation, under following conditions: diameter d=3 mm, and pitch p=0.25 mm. As shown in FIG. 7, the heat insulator was a silica cloth, the thermosetting polyimide film was UPILEX-25S (product name, manufactured by UBE Corporation, film thickness 25 μm), and the polyimide films to be bonded were UPILEX-25RN (product name, manufactured by UBE Corporation, film thickness 25 μm).

The test results are shown in FIG. 24. In FIG. 24 to FIG. 27, “Measured output” means an actually measured output for the CO₂ laser irradiation, and “Bonding part drawing speed” represents an average of three measurements. The test results in FIG. 24 indicate that bonding was possible in several cases where the bonding part drawing speed was in a range of 1.4 mm/min to 24.3 mm/min, and that bonding was possible in several cases where the measured output of the laser beam was in a range of 3.0 W to 4.1 W. From a viewpoint of extending the allowable range of the laser beam output, the bonding part drawing speed is preferably from not lower than 8 mm/min to not higher than 25 mm/min. From a viewpoint of preventing carbonization of the polyimide films or failure of bonding, the materials to be bonded are irradiated with a laser beam at an output of preferably from not less than 3.2 W to not more than 4.2 W.

### Example 2-3. Laser Bonding Test: Conditions for the Heat Insulator

A CO₂ laser bonding test was conducted with various types of heat insulator that was tightly attached to the bottom surface of the polyimide films to be bonded. The circles as shown in FIG. 22 were drawn by the arc-like irradiation, under following conditions: diameter d=2 mm, and pitch p=0.25 mm. The thermosetting polyimide film was UPILEX-25S (product name, manufactured by UBE Corporation, film thickness 25 μm), and the polyimide films to be bonded were UPILEX-25RN (product name, manufactured by UBE Corporation, film thickness 25 μm). The bonding states of following samples were compared: a sample in which the heat insulator was the vacuum layer as shown in FIG. 6, a sample in which the heat insulator was the silica cloth as shown in FIG. 7, and a sample in which a copper plate was used instead of the silica cloth and UPILEX-25S.

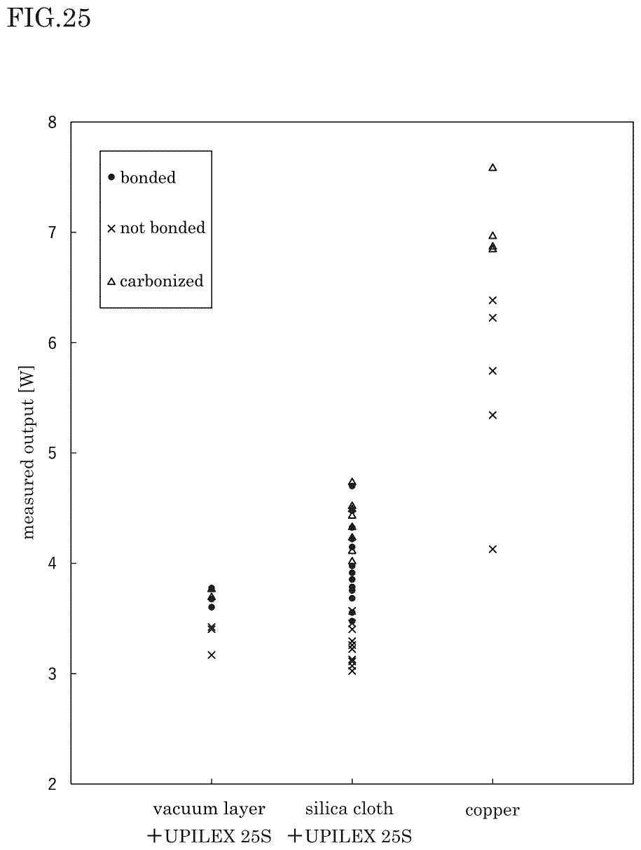

The test results are shown in FIG. 25. As indicated by the test results in FIG. 25, the polyimide films could not be bonded when the heat insulators were replaced by copper, and the polyimide films could be bonded when the heat insulator was the vacuum layer or the silica cloth. It has also turned out that, when the heat insulator was the vacuum layer, a preferable measured output of the laser beam for conducting the bonding operation was approximately in a range between 3.5 W and 4 W, and that, when the heat insulator was the silica cloth, a preferable measured output of the laser beam for conducting the bonding operation was approximately in a range between 3 W and 5 W.

### Example 2-4. Laser Bonding Test: Conditions for the Trail of the Laser Beam Irradiation

A CO₂ laser bonding test was conducted, with the laser beam irradiation being performed along a trail of “arc-like irradiation” shown in FIG. 22 and along a trail of “zigzag irradiation” shown in FIG. 23. As shown in FIG. 7, the heat insulator was a silica cloth, the thermosetting polyimide film was UPILEX-25S (product name, manufactured by UBE Corporation, film thickness 25 μm), and the polyimide films to be bonded were UPILEX-25RN (product name, manufactured by UBE Corporation, film thickness 25 μm).

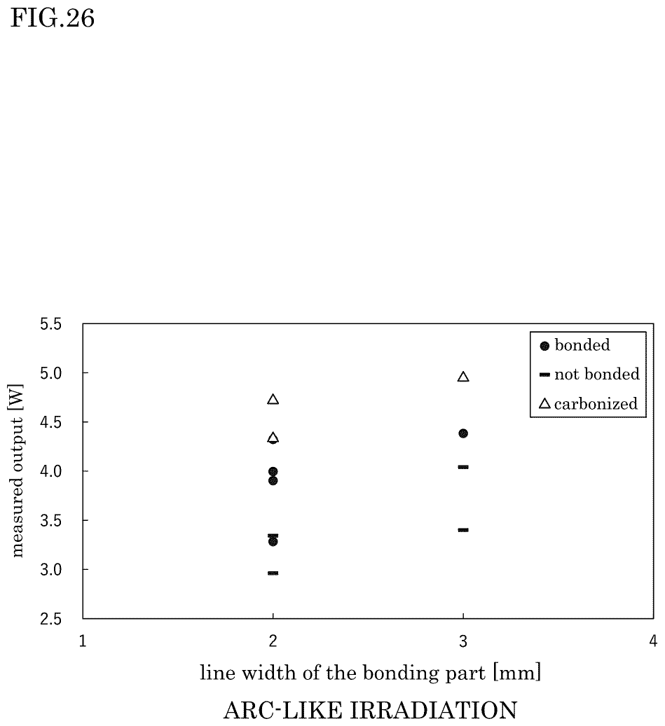

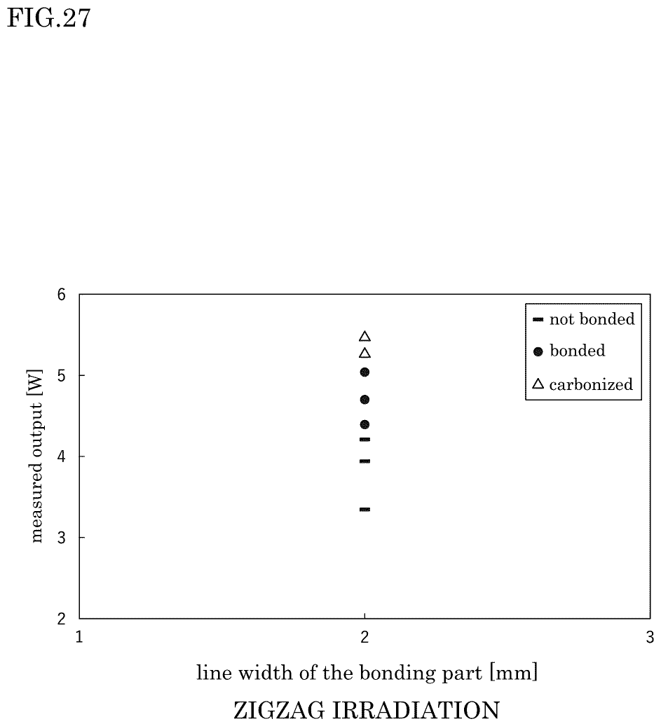

The test results are shown in FIGS. 26 and 27. The bonding part drawing speeds (v₂ in FIG. 22 and FIG. 23) were as follows: 37.9 mm/min when the line width in FIG. 26 (arc-like irradiation) was 2 mm; 25.3 mm/min when the line width in FIG. 26 (arc-like irradiation) was 3 mm; and 246 mm/min when the line width in FIG. 27 (zigzag irradiation) was 2 mm. As indicated by the test results in FIGS. 26 and 27, the arc-like laser beam irradiation shown in FIG. 22 and the zigzag laser beam irradiation shown in FIG. 23 could both achieve strip-shaped bonding with a width between 2 mm and 3 mm. The CO₂ laser bonding operation, controlled to provide a strip-shaped bonding part having a width between 2 mm and 3 mm, is assumed to be able to heat the polyimide films evenly to the inside. Incidentally, as described with reference to FIG. 8, linear laser beam irradiation of the polyimide films failed to heat the polyimide films evenly to the inside, and failed to bond the polyimide films to each other.

### Example 3-1. Bonding Test of a Polyimide Film to a Metal: Bonding Along the Mold Shape

For a bonding test of a polyimide film to a metal using the device shown in FIG. 2, the lower one of the superposed polyimide films F was replaced with a metal to be bonded, and the mold was replaced with one having a rectangular contact surface of 11.5 mm×12.5 mm. The polyimide film to be bonded was UPILEX-25RN (product name, manufactured by UBE Corporation, film thickness 25 μm), and the metal was a duralumin (A2017).

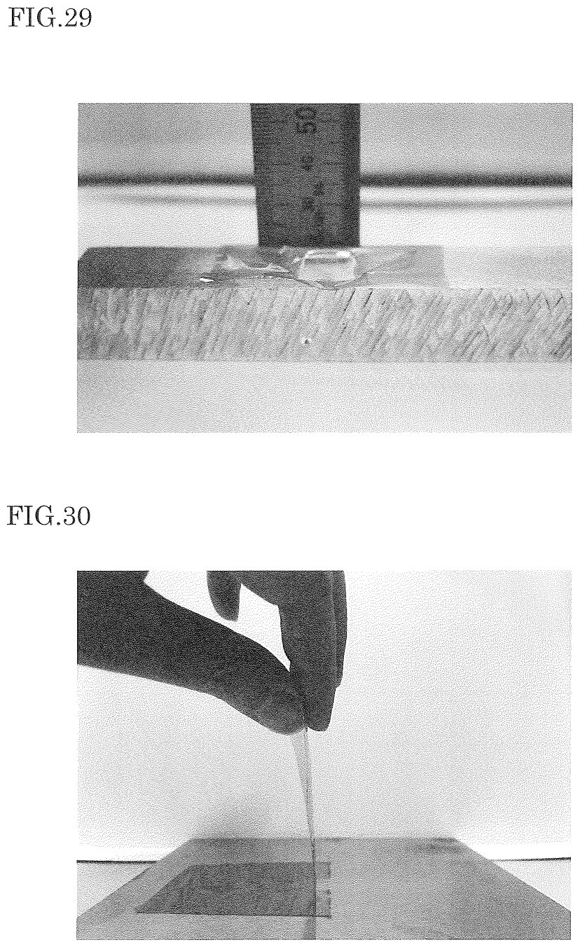

Conditions for bonding the polyimide film to the metal were as follows. The set temperature for the heater was 500° C. The contact pressure applied to the polyimide film by the heated mold (the hot plate) was 2.5 MPa. The contact time between the mold and the polyimide film was 5 minutes. FIG. 29 is a photographic copy showing a bonding part where the polyimide film was bonded to the duralumin (A2017) in this bonding test. A mold-shaped bonding part, which can be seen in the central part of this photograph, confirms that the difficult-to-melt polyimide film could be bonded to the duralumin.

### Example 3-2. Bonding Test of a Polyimide Film to a Metal: Bonding Across the Entire Film Surface

A bonding test of a polyimide film to a metal was conducted using the device shown in FIG. 28. The device shown in FIG. 28 heated the metal M by the heater 2 and allowed the entire surface of the polyimide film F to bond to the metal M (except the portion where the thermosetting polyimide film F′ was inserted therebetween to prevent bonding). In this Example, the mold 3 had a rectangular contact surface of 10 mm×100 mm. The mass of the weight 13 was 3.52 kg. Accordingly, the contact pressure applied by the weight 13 to the polyimide film F was 34.5 kPa ((3.51×9.81)/(10×100)≈34.5 [kPa]). The polyimide film F was bonded to the metal M in the following manner. First, the metal M was heated by the heater 2 until the actually measured temperature of the metal M reached 450° C. Thereafter, in the state shown in FIG. 28, the polyimide film F was heated for 5 minutes to effect the bonding. The polyimide film to be bonded was UPILEX-25RN (product name, manufactured by UBE Corporation, film thickness 25 μm).

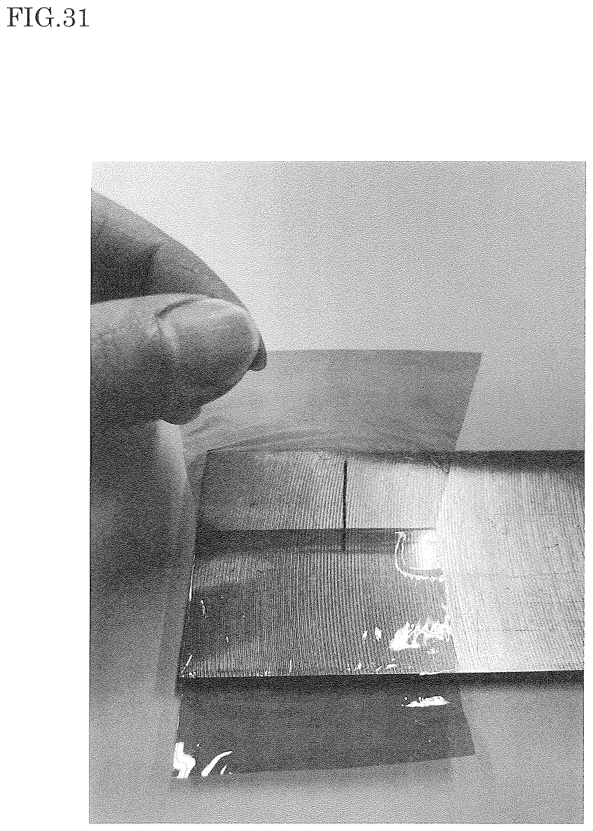

FIG. 30 is a photographic copy showing a bonding part where the polyimide film was bonded to the duralumin (A2017) in this bonding test. FIG. 31 is a photographic copy showing a bonding part where the polyimide film was bonded to a stainless steel (SUS430) in this bonding test. FIG. 30 confirms that the entire surface of the difficult-to-melt polyimide film could be firmly bonded to the duralumin. Regarding the bonding to the stainless steel, FIG. 31 confirms that the bonding part could be firmly bonded at a top right portion of in the photograph. In the case of FIG. 31, the surface roughness of the stainless steel (SUS430) is assumed to be a reason why the materials could not be bonded firmly across the entire surface.

As understood from the results of Examples 3-1 and 3-2, even a difficult-to-melt polyimide film can be directly bonded to a metal by a process of heating the polyimide film while a contact pressure is applied such that one surface of the polyimide film is tightly attached to a surface of the metal.

### INDUSTRIAL APPLICABILITY

Polyimide is not only lightweight but also has high heat resistance, cold resistance, and radiation/ultraviolet resistance. Nevertheless, conventional processing of polyimide films, which had to use adhesive agents or fixing metal parts, could not fully utilize such advantageous characteristics of polyimide. The polyimide film bonding method and the bonding device according to the present invention enable bonding of polyimides, in particular difficult-to-melt polyimides having a high melting point and high heat resistance, and can thereby extend the availability of polyimides in extreme environments.

In the information equipment industry and the space industry, the present disclosure enables manufacture of products that make use of high characteristics inherent to the polyimide films, without sacrificing durability of the polyimide films, and hence enables low-cost production of space devices resistant to extreme environments. The present disclosure can be also suitably applied to devices that need adaptation to specific environments such as the deep sea or the inside of a nuclear power plant.

In the automotive industry, the present disclosure is expected to be applicable to, for example, batteries, peripheral components for harnesses, etc. in fuel cell vehicles that use extremely-low-temperature liquid hydrogen and in electric vehicles that require high insulation and high heat resistance.

In the automotive/aviation industries, the polyimide films may be increasingly used as metal substitutes, owing to their tensile strength equivalent to that of metals and their directly bondable characteristics. In this respect, reduction of the car body weight, extension of the distance to empty are expected, for example.

In the robot industry, the present inventors have been promoting an academic field called Filmotics (Film+Robotics) that covers ultralight/ultrathin robotics in which all of the skeleton structure, the actuator, and the sensor are made of films only. Filmotics is a robot system featured by a mass-volume ratio that is far apart from the one in conventional robotics. Researches on this new microrobot field are under way, with expectations for various characteristics including functionality of activities superior to those of insects. The bonding method, the bonding device, and the polyimide film having a bonding part bonded by this bonding method, according to the present invention, are suitably applied to the microrobot.

### REFERENCE SIGNS LIST

1 support member
2 heater
3 mold (hot plate)
4 silica cloth
5 support member
6 sandwiching member
7 conductive member (hot plate)
8 sandwiching member
9 vacuum layer
10 support member
11 sandwiching member
12 sandwiching member
13 weight
F polyimide film to be bonded
F′ thermosetting polyimide film
L lens provided in the laser emission part

1. A polyimide film bonding method comprising:
bonding two polyimide films to each other by bringing a hot plate into contact with a portion where the two polyimide films are superposed,
wherein a heating temperature of the polyimide films by the contact with the hot plate is 450° C. or higher, and
wherein a contact time between the polyimide films and the hot plate is 12 seconds or less.

2. The method for bonding the polyimide films to each other according to claim 1,
wherein each of the two polyimide films is selected from the group consisting of a polyimide film containing a polyimide that has a repeating unit represented by following Formula (1), and a polyimide film comprising a polyimide that has a repeating unit represented by following Formula (2).

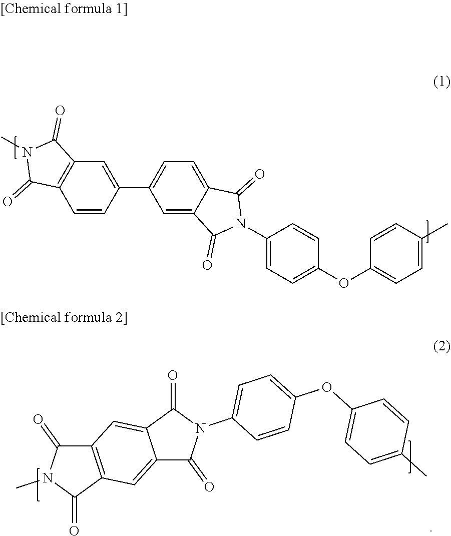

3. The method for bonding the polyimide films to each other according to claim 1,
wherein the hot plate is brought into contact with the polyimide films to apply a contact pressure on the polyimide films.

4. The method for bonding the polyimide films to each other according to claim 3,
wherein a conductive member is used as the hot plate, and
wherein while the conductive member has been kept in contact with the polyimide films in a tightly attached manner under the contact pressure, the conductive member is heated instantaneously by application of a voltage to the conductive member, and is thereby allowed to serve as the hot plate.

5. A polyimide film bonding method comprising:
bonding two polyimide films to each other by irradiating, with a laser beam, a portion where the two polyimide films are superposed,
wherein a top surface of the superposed polyimide films is irradiated with the laser beam while a bottom surface of the superposed polyimide films is kept tightly attached to a heat insulator.

6. The method for bonding the polyimide films to each other according to claim 5,
wherein the top surface of the superposed polyimide films is irradiated with the laser beam, with the polyimide films being displaced from a focal point of the laser beam.

7. The method for bonding the polyimide films to each other according to claim 5,
wherein the polyimide films are irradiated with the laser beam while the laser beam is moved in an arc-like path, a polygonal path, or a zigzag path.

8. The method for bonding the polyimide films to each other according to claim 5,
wherein a strip-shaped bonding part is formed.

9. A film bonding device for performing the polyimide film bonding method according to claim 5, the bonding device comprising a support member that supports a bottom surface of a film or films, and a laser emission part that emits a laser beam onto the film or films,
wherein the support member has an insulating layer at a position to be in contact with the bottom surface of the film or films,
wherein the insulating layer includes a surface layer to be in contact with the film or films and a vacuum layer placed under the surface layer, and
wherein the surface layer is made of a thermosetting polyimide film.

10. A polyimide film comprising a bonding part where polyimide films are bonded to each other by the bonding method according to claim 1.

11. A polyimide film comprising a bonding part where a first polyimide film and a second polyimide film are bonded by the polyimide film bonding method according to claim 1,
wherein each of the first polyimide film and the second polyimide film is selected from the group consisting of a polyimide film comprising a polyimide that has a repeating unit represented by following Formula (1), and a polyimide film containing a polyimide that has a repeating unit represented by following Formula (2).

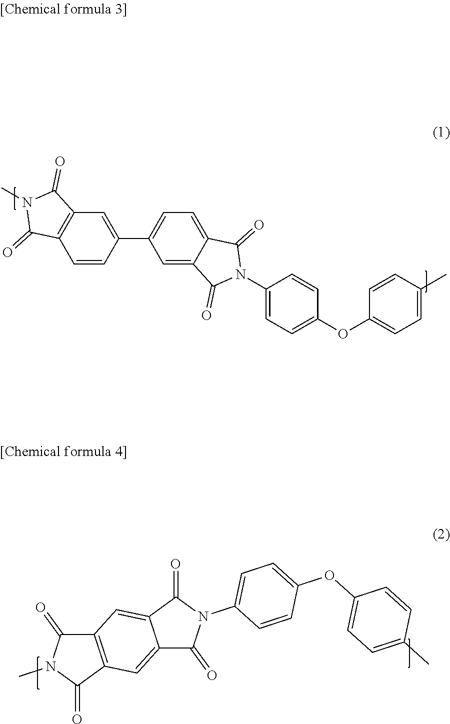

12. A polyimide film bonding method comprising:
bonding a polyimide film to a metal by heating the polyimide film while a contact pressure is applied such that one surface of the polyimide film is tightly attached to a surface of the metal.

13. A bonded structure comprising a polyimide film and a metal,
comprising a bonding part where the polyimide film and a surface of the metal are bonded by the bonding method according to claim 12.

14. A bonded structure comprising a polyimide film and a metal,
comprising a bonding part where the polyimide film and a surface of the metal are bonded by the polyimide film bonding method according to claim 12,
wherein the polyimide film is selected from the group consisting of a polyimide film comprising a polyimide that has a repeating unit represented by following Formula (1), and a polyimide film comprising a polyimide that has a repeating unit represented by following Formula (2). [chemical structure]
